(19) United States
(12) Patent Application Publication
(10) Pub. No.: US 2014/0231183 A1
(43) Pub. Date: Aug. 21, 2014

(54) ELEVATOR CAR

(71) Applicants: Pekka HALONEN, Tervakoski (FI); Aki HAIKONEN, Hyvinkaa (FI)

(72) Inventors: Pekka HALONEN, Tervakoski (FI); Aki HAIKONEN, Hyvinkaa (FI)

(73) Assignee: Kone Corporation, Helsinki (FI)

(21) Appl. No.: 14/260,820

(22) Filed: Apr. 24, 2014

Related U.S. Application Data
(63) Continuation of application No. PCT/EP2011/069604, filed on Nov. 8, 2011.

(51) Int. Cl. B66B 11/02

(52) U.S. Cl. CPC B66B 11/0226
USPC 187/334; 29/525.11

(57) ABSTRACT

The invention relates to an elevator car comprising a support frame, a floor structure and a ceiling structure, as well as at least one car door, and side walls extending between the floor structure and the ceiling structure, wherein the side walls are formed from several wall elements, which are aligned end-to-end or end-to side in corners, wherein the wall elements are composite panels consisting of at least one support material and at least one noise insulating material, that the elevator car comprises at least one flatbar, extending over the surface of both adjacent wall elements, and covering the joint between them, which flatbar comprises or is connectable with fixing elements to at least one of both adjacent wall elements. Via this means the joint between two noise insulating wall elements does prevent any essential noise leakage.

This application is a continuation of PCT International Application No. PCT/EP2011/069604 which has an International filing date of Nov. 8, 2011, the entire contents of which are incorporated herein by reference.

The present invention refers to an elevator car comprising a support frame, a floor structure and a ceiling structure, as well as at least one car door and side walls extending between the floor structure and the ceiling structure. As the elevator cars have various sizes according to the specified nominal capacity of an elevator, usually the side walls consist of several wall elements which are aligned end-to-end within one wall. In a corner of the elevator car where one side wall meets another side wall so that the wall elements to be connected are arranged perpendicular to each other the wall elements are arranged end to side. The present invention relates to this basic layout of an elevator car whereby it is particularly directed to high rise elevators or fast driving elevators where the noise of the fast running elevator car increases essentially compared to usual elevators with car velocities about 1 m/s. Elevator cars of such high rise elevators have velocities of two to ten m/s. Accordingly, there is a desire for elevator cars with a good noise insulation.

It is therefore object of the present invention to provide an elevator car with good noise insulation properties which can be easily configured to different cars sizes and which is fast and economic to build.

The object of the invention is solved with an elevator car according to claim 1. A method for building an elevator car with good noise insulating properties is subject matter of claim 16. Preferred embodiments of the invention are subject matter of the corresponding sub claims.

According to the invention wall elements are used with good noise insulating properties comprising at least one support material, e.g. panels of metal sheet, plastic panels or fiberboard plates (MDF) and at least one noise insulating material as e.g. stone wool or glass wool. For the wall elements also combinations of several support materials and noise insulating materials may be chosen as desired. The use of wall elements with good insulting properties essentially reduces the noise level in the elevator car even during fast travel of the elevator car in a high rise elevator. Furthermore, a particular joint is provided in the connection area of two adjacent wall elements. Accordingly, one flatbar is used which covers a part of both adjacent wall elements to be connected on both sides of the joint as well as the connecting area itself. This flatbar is connected with fixing elements to at least one of both adjacent wall elements, preferably to both adjacent wall elements. With this solution a kind of labyrinth seal is provided in the joint area between both adjacent wall elements which labyrinth seal has good noise insulting properties. Furthermore, the joint between the two wall elements is not leaking so that it does not allow noise to pass through. Furthermore, in case of any damage single wall elements may be changed or replaced one by one, if needed. The connecting of wall elements by means of the flatbars is fast and no special tools are needed.

Principally it is possible to fix the flatbar only to one of the adjacent wall elements. Advantageously, the flatbar is connected via fixing elements to both adjacent wall elements which results in a better rigidity of the joint and better noise insulating properties. As fixing elements bolts, particularly punch nuts may be used to fix the flatbar to the wall elements.

The flatbar maybe any longitudinal band, strip, sheet or bar, e.g. a metal or plastics sheet strip. The flatbar could be embodied as a one-piece element which extends from the floor to the ceiling of the car, e.g. over the total height of the side walls, or it may comprise several parts are mounted above each other in vertical direction. Preferably the flatbar is an element which only extends in one plane and preferably having a thickness between 1 and 5 mm. Such a flatbar is easy to handle and allows a fast and economic joint between adjacent wall elements as it only has to be brought to the surfaces thereof and does not interfere with the inner structure or end structure of the wall elements.

Preferably the flatbar is mounted on the surface of the wall elements facing the car inside because in this case the side walls can be easily installed from the elevator car. But it is also possible to mount the flatbars on the side of the wall elements facing the shaft. If a very rigid construction is to be achieved the flatbars may be mounted on both sides of the wall elements.

On the side facing the wall elements the flatbar may comprise a sealing or damping material as e.g. rubber or soft plastics to improve the noise insulation in the area of contact to the wall element surface.

Preferably the flatbar comprises perforations which are to be penetrated by bolts for fixing the flatbar to one or both adjacent wall elements. This fixing of the flatbar to adjacent wall elements can be performed very easy and fast. By this way the vertical as well as horizontal mutual alignment and fixation of the wall elements is easy to achieve.

In an advantageous embodiment of the invention the perforations comprise first and second perforations and the first perforations extend over the first of two adjacent wall elements and the second perforations extend over the second of said wall elements. With this construction the flatbar can be easily mounted to both adjacent wall elements.

Preferably in this case the perforations comprise or consist of tilted portions, whereby the tilted portions of the first and second perforations are tilted towards each other. With such a configuration of the perforations it is possible to use the tilted portion for pressing the adjacent wall elements together by moving the flatbar vertically.

In an embodiment which is easy to manufacture the perforations are embodied as or comprise longholes, in which the bolts can easily slide in the direction of the longitudinal axis of the longholes.

Preferably, the perforations in the flatbar have a keyhole shape with one larger diameter hole connected to a longhole with a smaller width than the diameter of the hole, which larger diameter hole is larger than the diameter of the bolt heads. In this embodiment of the invention the bolts can be fixed to the wall elements in the perforation pattern of the flatbar without the necessity to arrange the flatbar in mounting position beforehand. After fixing of the bolts in said pattern in the wall elements the flatbar can be arranged in mounting position by simply putting it with the holes over the bolt heads so that the flatbar is held between the bolt heads and the wall elements. Preferably in this case the bolts are fixed in a first mounting position which still allows the movement of the flatbar with respect to the wall elements, i.e. the distance of the bolt heads to the wall element surface is slightly larger than the thickness of the flatbar.

In one alternative longholes of the first perforations are arranged side by side to the longholes of the second perforations. This arrangement is easy to handle. On the other side it is however possible to arrange the longholes of both perforations alternately in vertical direction.

Preferably several sets of two perforations located side by side are located in the flatbar at different height levels, e.g. 3 to 8 sets to provide a rigid and sealed connection between both adjacent wall elements.

In an advantageous embodiment of the invention the longholes or the tilted portions of the perforations are extending mainly vertically with a slight tilting angle to each other. The tilting angle may preferably be in a region of 5 to 45 degrees, preferably 10 to 25 degrees. Via this arrangement of the longholes the two adjacent wall elements are pressed together by moving the flatbar in vertical direction so that the already pre-fixed bolts (mounted in the first mounting position) slide along the tilted longholes whereby the mutual distance of the longholes diminishes with the moving distance of the flatbar whereby the two bolts are pressed together by the longholes which also presses the noise insulting wall elements together. By this means a gap the joint between two wall elements can be avoided so that the joint between two adjacent wall elements is not noise leaking and the noise insulting properties of the wall elements are maintained also in the joints of the wall elements.

It shall be understood that any noise insulting structure panel comprising supporting material as well as insulating material can be used for the wall elements of the elevator car.

Preferably, the thickness of the wall elements in the area where the flatbar covers the wall element is reduced by the thickness of the flatbar (or by the thickness of the flatbar plus the thickness of the bolt heads) so that the mounted flatbar in alignment with the surface of the wall elements. Because of this the flatbar (and the bolts) do not hamper the mounting of the decorative panels on the inner side of the wall elements and/or the fixing of the side walls to additional support structures extending between the floor structure and the ceiling structure of the elevator car.

The invention of course also aims for an elevator comprising at least one elevator car according to the above given specifications.

The inventive method for mounting the side walls in the elevator car uses an elevator car consisting of a support frame, a floor structure and a ceiling structure, as well as at least one car door and side walls extending between the floor structure and the ceiling structure, wherein the side walls are formed from several wall elements, which are aligned end-to-end or end-to side in corners, wherein flatbars are used for the connection between two adjacent wall elements, which flatbars comprise perforations to be penetrated by bolts to be fixed to the wall elements, wherein the perforations in the flatbar comprise first perforations extending over the first of both adjacent wall elements which are to be connected and second perforations extending over the second of said adjacent wall elements, which perforations comprise longholes or tilted portions of the first and second perforations which are tilted towards each other.

Of course, first the floor and ceiling structures of the elevator car have to be mounted to the car frame. Then the side walls of the elevator car are built up by connecting wall elements end to end. On this behalf two adjacent wall are located end to end so as to be in contact to each other. Then the bolts are fixed to the wall elements in line with the pattern of the holes in the flatbar in a first mounting position in which the bolt head has a sufficient distance from the wall element surfaces such that the movement of the flatbar with respect to the bolts is still possible. It is irrelevant whether flatbar is provided in its mounting place before or after fixing the bolts in their first mounting position in the wall elements.

After the bolts have been fixed in their first mounting position to the adjacent wall elements and the flatbar is mounted e.g. by putting the holes over the bolt heads, the flatbar is moved in vertical direction so that the flatbar grips the bolts in the longholes. Accordingly, by moving the flatbar in vertical direction so that the bolts travel away from the holes and into the longholes. With the further movement of the flatbar with respect to the wall elements the bolts are pressed by the longholes or tilted portions towards each other which leads to the fact that also the wall elements are pressed towards each other. Via this method a tight joint between two adjacent wall elements is provided which avoids any noise leakage. The vertical movement of the flatbar is stopped when the pressure between two wall elements is in a desired range which ensures that no gap is present any longer between the two wall elements. Afterwards the bolts are tightened (screwed) into a second mounting position wherein the flatbar is tightly (immovable) pressed between the bolt heads and the wall element surfaces. This provides on optimal noise insulating joint with only minor mounting effort. No special tools are needed and the insulation can be performed without building stands on the shaft. The connection of the wall elements to the floor and ceiling structures is performed in line with adapted prior art technology. This also holds true for the mounting of the car doors and other structural elements of the elevator car.

It shall be clarified that the perforations can also be realized only by longholes without a larger diameter hole connected thereto. In this case the flatbar has to be brought into the mounting position before drilling the bolts into the wall elements.

It is further possible to place the longholes tilted in different directions vertically offset so that the two different longholes are not located side by side but vertically in different positions.

It shall be clarified that the flatbar can also be used for the connection of two wall elements in the corner of the car where the two adjacent wall elements are arranged perpendicular to each other. In this case one end of the first wall element is in contact with the surface of the second wall element.

For the desired tightening pressure effect on the adjacent wall elements the perforations do not need to be longholes, but both perforations needs to have a tilted portion whereby the tilted portions of both perforations are tilted towards each other which allows the bolts pressed together by a vertical movement of the flatbar. Preferably the tilted portion should be located in both perforations mutually at their opposite sides.

Furthermore, a flatbar may be located at the inner side and/or outer side of the elevator car.

It shall be understood that the joint line between panels could be other than a vertical one. Further the invention may be applied to other than elevator car panel joints.

The invention is now described in detail with reference to the embodiments in connection with the enclosed drawings.

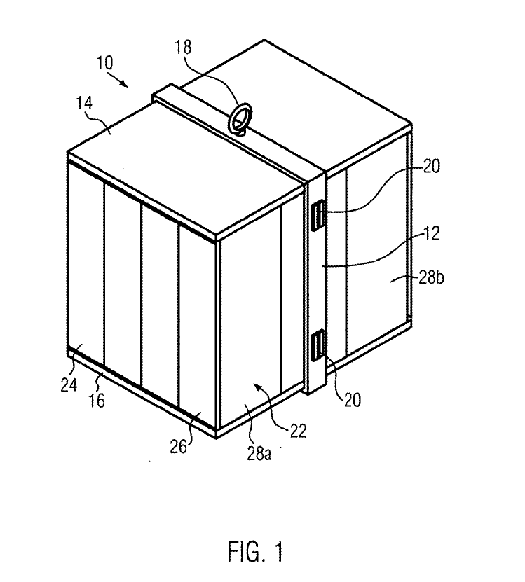

FIG. 1 shows a perspective schematic view of an elevator car,

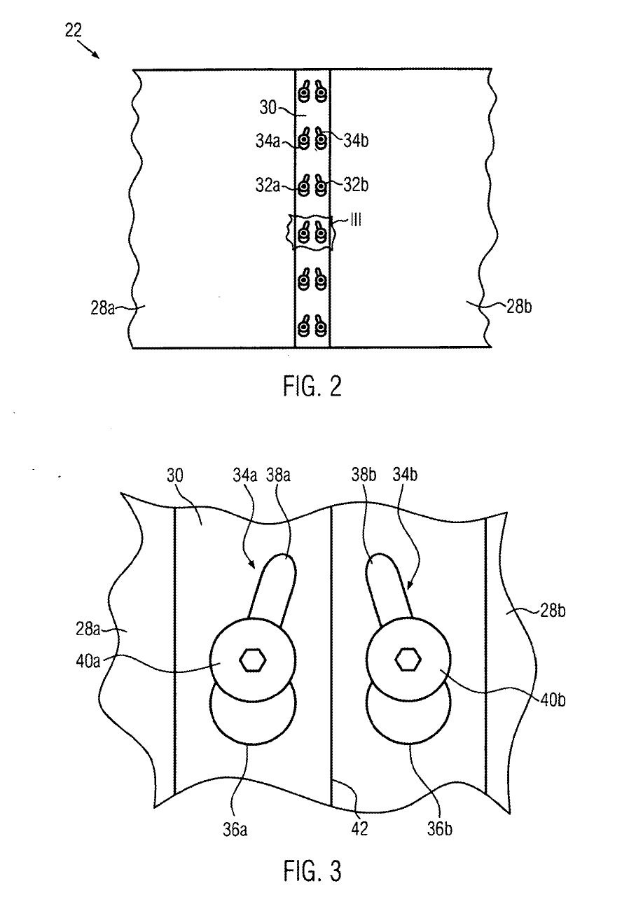

FIG. 2 shows a detail from FIG. 1 showing two wall elements from the inner side of the elevator car connected by a flatbar,

FIG. 3 shows an enlarged detail III from FIG. 2,

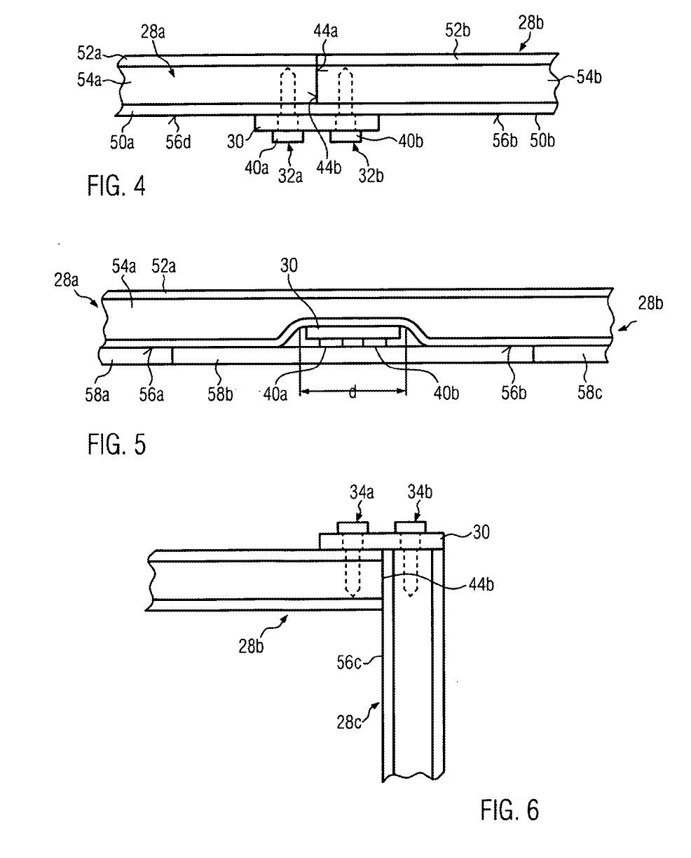

FIG. 4 shows a cross sectional view of the joint region of two adjacent wall elements of a side wall,

FIG. 5 shows a cross sectional view of the joint region of two wall elements carrying decorative panels, and

FIG. 6 shows the joint region of two wall elements of perpendicular side walls in a car corner,

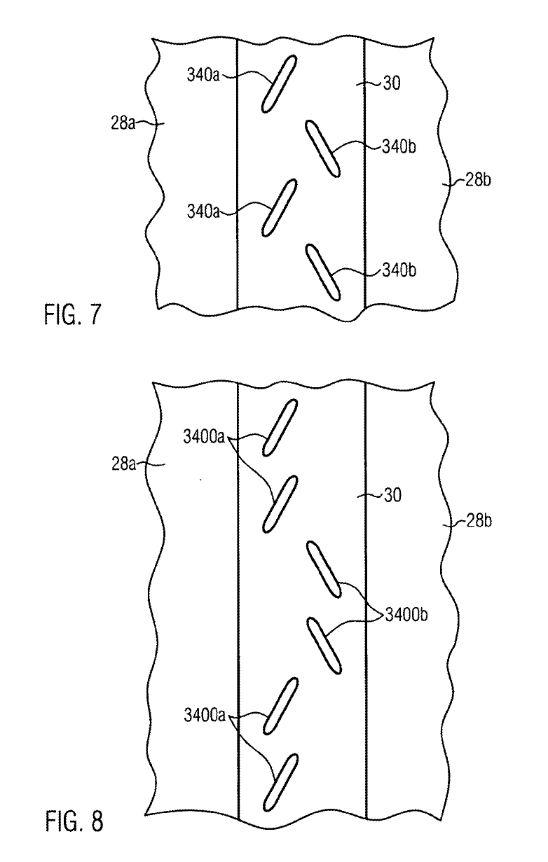

FIG. 7 shows a side view of another embodiment of a joint between two wall elements showing another perforation pattern in a flatbar,

FIG. 8 shows a side view of a third embodiment of a joint between two wall elements showing another perforation pattern in a flatbar, and

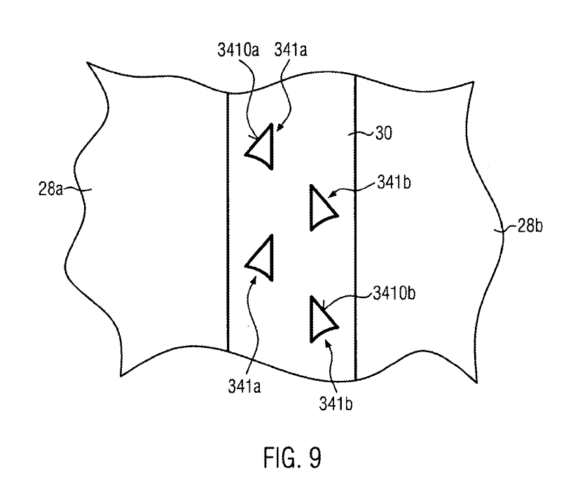

FIG. 9 shows a side view of a fourth embodiment of a joint between two wall elements showing perforations with a tilted portion.

FIG. 1 shows an elevator car 10 having a car frame (or car sling) 12 carrying a ceiling structure 14 and a floor structure 16. The car frame 12 further comprises means for fixing suspension ropes, e.g. a diverting pulley 18 and means 24 for guiding the elevator car along guide rails. The elevator car has furthermore other components as e.g. gripping devices which are—like the suspension means 18 or the guiding means 20—not relevant for the present invention. Between the ceiling structure 14 and floor structure 16 side walls 22 extend in vertical direction. On at least one side of the elevator car elevator car doors 24, 26 are provided which are able to open the telescopic manner to allow entrance into the elevator car 10. The car doors may deviate from those shown in the figure. The embodiment and number of the car doors is not relevant for the invention. The side walls on the side and back of the elevator car consist of wall elements 28a, 28b which are connected in their end region whereby the joint between both wall elements 28a, 28b, 28c is connected via a flatbar 30 and bolts 32 in a manner which is described later on in more detail.

The invention relates to this connection between different side walls 28a, 28b and 28c. The wall elements 28a, 28b, 28c are connected to the floor structure 16 and the ceiling structure 14 in a per se known manner.

FIG. 2 shows the joint between two wall elements 28a, 28b of a side wall 22 in a more detailed manner from the inner side of the elevator car. The flatbar 30 is a strip of metal sheet extending vertically and covering the surface of both adjacent wall elements 28a, 28b (see also FIG. 4) which are arranged end-to-end.

The flatbar 30 has several sets of keyhole perforations 34a, 34b located side by side which are shown in more detail in FIG. 3. Each keyhole perforation 34a, 34b has a circular hole 36a, 36b with a larger diameter connected to a longhole or slot 38a, 38b.

The diameter of the holes 36a, 36b is slightly larger than the diameter of the bolt head 40a, 40b. The longholes or slots 38a, 38b of one pair of perforations extend essentially vertically but are slightly inclined in an angle of 5-30 degrees relative to each other. Accordingly, the right keyhole perforation 34a, 34b is identical to the left keyhole perforation 34a but mirrored with respect to the center axis 24 of the flatbar 30.

As is it derivable from FIG. 2 the flatbar 30 comprises several pairs of the side by side perforations 34a and 34b at different height levels.

The fixing of two wall elements 28a, 28b is performed as follows:

First the two wall elements 28a, 28b to be connected are located side by side so that their end faces 44a, 44b are in contact. Thereafter bolts 32a, 32b are drilled into the wall elements 28a, 28b in a pattern corresponding to the pattern of the holes in the flatbar. The bolts 32a, 32b are not drilled up to the end but to a first mounting position which ensures the movement of the flatbar between the corresponding bolt heads 48a, 48b and the surface of the wall elements 28a, 28b. After having the bolts 32a, 32b fixed to both wall elements 28a, 28b the flat bar is put onto the bolts so that the bolt heads 48a, 48b pass through the holes 36a, 36b of the flatbar. Then the flatbar is moved downwards whereby the two bolts 34a, 34b which are fixed to the different wall elements 28a, 28b are pressed together via the tilted longholes. By this action both wall elements 28a, 28b are pressed together so that any gap between the two end faces 44a, 44b of the two wall elements is removed. Now the bolts 32a, 32b are fixed into their second mounting position where they press the flatbar 30 tight (immovable) between the bolt heads 48a, 48b and the surface of the wall elements 28a, 28b.

On the other side the flatbar 30 forms together with the wall elements 28a, 28b a kind of labyrinth seal with also prevents noise from passing through the joint between both wall elements.

FIG. 4 further shows that each wall element 28a, 28b consists of two metal sheets 50, 52 between which a noise insulating layer 54 is arranged which is for example stone wool, glass wool or any other noise insulating material. It is also possible that the metal sheets 50, 52 have anchors or fixing elements to improve the connection between the sheet 50, 52 and the noise insulating material 54. The metal sheets 50, 52 may also have perforations which are penetrated by the noise insulating material to improve the mutual connection of these layers. Of course, the layers can be arranged differently from the arrangement shown in FIG. 4.

FIG. 5 shows the same view as FIG. 4 with a different embodiment wherein within the width d the flatbar 30 the thickness of the wall elements 28a, 28b is reduced by the thickness of the flatbar 30 and the thickness of the bolt heads 40a, 40b. In this arrangement the surface of the bolt heads 40a, 40b is aligned with the surface 56a, 56b of the wall elements 28a, 28b. This facilitates or enables the mounting of decorative panels 58a, 58b, 58c on the inner surface of the wall elements 28a, 28b. Decorative panels 58a, 58b, 58c could be made for example from marble, metal or wood according to the desired design of the customer. At it is clearly seen from FIG. 5 the flatbar 30 and the bolt heads 48a, 48b do not interfere with the mounting of the decorative panels 58b on the inner surface 56a, 56b of the wall elements 28a, 28b.

FIG. 6 shows the mounting of two wall elements 28b, 28c in the corner region of the elevator car 10, wherein the wall elements 28b, 28c are perpendicular to each other. In this embodiment the end face 44b of the first wall element 28b is connected to the surface 56c of the other wall element 28c. The joint region between both wall elements 28b, 28c is again covered with a flatbar 30 which is fixed to both wall elements with bolts 34a, 34b in the same manner as it has been discussed in connection with FIGS. 2 to 4.

FIGS. 7 and 8 show different patterns of perforations in the flatbar 30. In FIG. 7 the perforations only consist of longholes 340a,b. Anyway instead of longholes they may consist of keyhole perforations as shown in FIG. 3. In this embodiment the perforations 340a to be connected with the first wall element 28a and the perforations 340b to be connected with the second wall element 28b are vertically offset, so that they are arranged in vertical direction in an alternating succession.

In FIG. 8 the perforations 3400 a to be connected with the first wall element 28a and the perforations 3400 b to be connected with the second wall element 28b are vertically offset, but in a way that always two first perforations 3400a of follow two second perforations 3400b in vertical direction, which pattern is repeated along the vertical axis of the flatbar.

According to FIG. 9 instead of tilted longholes the perforations 341a, 341b may have any shape which comprises a tilted portion 3410a,b whereby the tilted portion 3410a,b of both perforations 341a,b is mirrored against the center line 24 of the flatbar 30 so that the inclined or tilted portions 3410a,b of both perforations 341a,b are tilted towards each other. The tilted portion should be located in both perforations mutually at their opposite sides (i.e. facing away from each other).

It should be clear for the skilled person that the above mentioned embodiments are not restricting the invention but the invention may be carried out within the scope of the appended patent claims.

The frame of the elevator car may deviate from the one shown in FIG. 1. Accordingly, it may consist of several parallel multiple frame parts arranged side by side. Furthermore, the connection of the floor and ceiling structures 16, 14 to the frame 12 is not relevant for the invention.

The connection of the wall elements 28a, 28b, 28c to the floor or ceiling structures 16, 14 is performed in line with prior art. Furthermore, the connection of the wall elements 28 to door sections of the car is realized in line with prior art technology and not part of the invention.

Of course there may be several car doors on different positions of the elevator car for example in the front and back. Furthermore, the car doors may be turn doors instead of telescopic doors or sliding doors.

On the inner side of the wall elements decorative panels may be fixed. Furthermore on the outer side of the wall elements 28a, 28b, 28c supporting structures maybe located as e.g. a supporting wall or supporting beams to which the wall elements are fixed in a per se known manner.

1. Elevator car comprising a support frame, a floor structure and a ceiling structure, as well as at least one car door, and side walls extending between the floor structure and the ceiling structure, wherein the side walls are formed from several wall elements, which are aligned end-to-end or end-to side in corners, wherein the wall elements are composite panels consisting of at least one support material and at least one noise insulating material, that the elevator car comprises at least one flatbar, extending over the surface of both adjacent wall elements, and covering the joint between them, which flatbar comprises or is connectable with fixing elements to at least one of both adjacent wall elements.

2. Elevator car according to claim 1, wherein the flatbar is fixed by the fixing elements to both adjacent wall elements.

3. Elevator car according to claim 1, wherein the
flatbar comprises perforations to be penetrated by bolts, which are fixed to the wall element(s).

4. Elevator car according to claim 3, wherein the perforations comprise first and second perforations, and that the first perforations extend over the first of two adjacent wall elements and the second perforations extend over the second of said wall elements.

5. Elevator car according to claim 4, wherein the perforations are comprising or consisting of tilted portions, whereby the tilted portions of the first and second perforations are tilted towards each other.

6. Elevator according to claim 5, characterized in that the tilted portions are longholes.

7. Elevator according to claim 6, wherein the perforations in the flatbar have a keyhole shape with one larger diameter hole connected to a longhole with a smaller width than the diameter of the hole, which larger diameter hole is larger than the diameter of the bolt heads.

8. Elevator car according to claim 5, wherein the longholes of the first perforations are arranged side by side to the longholes of the second perforations.

9. Elevator car according to claim 3, wherein the bolts are punch nuts.

10. Elevator car according to claim 1, wherein the support material of the wall elements is sheet metal.

11. Elevator car according to claim 1, wherein the noise insulating material of the wall elements is rockwool.

12. Elevator car according to claim 1, wherein the flatbar is a strip of metal sheet.

13. Elevator car according to claim 1, wherein the region where the flatbar is covering the surface of the adjacent wall elements the thickness of the wall elements is reduced.

14. Elevator car according to claim 13, wherein the thickness reduction of the wall elements corresponds to the thickness of the flatbar and optionally also the thickness of the bolt heads.

15. Elevator comprising an elevator car according to claim 1.

16. Method of building up an elevator car consisting of a support frame, a floor structure and a ceiling structure, as well as at least one car door and side walls extending between the floor structure and the ceiling structure, wherein the side walls are formed from several wall elements, which are aligned end-to-end or end-to side in corners, wherein flatbars are used for the connection between two adjacent wall elements, which flatbars comprise perforations to be penetrated by bolts, which are fixed to the wall element(s), wherein the perforations in the flatbar comprise first perforations extending over the first of both wall elements and second perforations extending over the second of both wall elements, which longholes of the first and second perforations are tilted towards each other,
in which method a succession of following steps is carried out for the building up of the side walls:
both adjacent walls elements are located end-to end or end-to-side in a corner of two perpendicular extending side walls,
two bolts are fixed to the wall elements into a first fixing position, wherein the bolts are not driven into the wall elements as far as they go to allow the flatbar to be movable with respect to the bolts, whereby the first of both bolts is fixed to the first of the adjacent wall elements and the second of both bolts is fixed to the second of the adjacent wall elements, which two bolts are fixed in a distance which corresponds to the pattern of perforations arranged in the flatbar, whereby,
previously to, during or after the above step the flatbar is put to its mounting location,
the flatbar is moved relative to the bolts in vertical direction, by which movement the adjacent wall elements are caused by the force of the longholes on the bolts to be pressed together,
in a vertical position of the flatbar wherein the pressure force on the wall elements is as desired, the bolts are fixed in a second fixing position in which the flatbar is pressed tightly between the wall elements and the bolt heads.
